(19) United States
(12) Patent Application Publication
(10) Pub. No.: US 2022/0247027 A1
(43) Pub. Date: Aug. 4, 2022

(54) Automobile Battery Box and Enclosed Environmental Control System

(71) Applicant: Daniel Kahmke, St. Louis, MO (US)

(72) Inventor: Daniel Kahmke, St. Louis, MO (US)

(21) Appl. No.: 17/164,832

(22) Filed: Feb. 1, 2021

(51) Int. Cl. H01M 50/249; B60H 1/00; H01M 10/6572; H01M 50/204; H01M 10/6557; H01M 10/6563; H01M 10/625; H01M 10/613; H01M 50/244

(52) U.S. Cl. CPC H01M 50/249; B60H 1/00278; H01M 10/6572; H01M 50/204; H01M 2220/20; H01M 10/6563; H01M 10/625; H01M 10/613; H01M 50/244; H01M 10/6557

(57) ABSTRACT

Aspects of the present invention relate to a slidable or removable battery box for an electric vehicle (EV). One or more battery cells are positioned on or within an exemplary battery box, having one or more active elements, passive elements, or some combination thereof, for cooling or otherwise maintaining an operational temperature or range of temperatures for the environment in or around the battery cells within the battery box.

### CROSS-REFERENCE TO RELATED APPLICATION

This application claims the benefit of U.S. Provisional Application 62/968,155, filed Jan. 31, 2020.

### BACKGROUND

At present, electric vehicles and, specifically, their power systems, remain difficult to access, service, and/or maintain. Generally speaking, the batteries utilized by electric vehicles are integrated unit under the footprint of the vehicle, requiring proprietary tools and methods, and a significant investment of time to do so. As such, in the event of emergency, such as electrical or battery fire, the occupants of the present vehicles and their cargo have a significant risk of harm or injury.

### BRIEF SUMMARY OF THE INVENTION

The following presents a simplified summary in order to provide a basic understanding of some aspects of the invention. This summary is not an extensive overview. It is not intended to identify key or critical elements of the invention or to delineate the scope of the invention. The following summary merely presents some concepts of the invention in a simplified form as a prelude to the more detailed description provided below.

Aspects of the present invention relate to a slidable or removable battery box for an electric vehicle (EV). One or more battery cells are positioned on or within an exemplary battery box, having one or more active elements, passive elements, or some combination thereof, for cooling or otherwise maintaining an operational temperature or range of temperatures for the environment in or around the battery cells within the battery box.

The exemplary embodiments described herein and shown in the drawings show various elements in an exemplary configuration. It should be understood that other arrangements of the elements, omission of elements, addition of elements, or some combination thereof, are within the scope of the present invention.

### BRIEF DESCRIPTION OF THE DRAWINGS

FIGS. 1A-1F illustrate exemplary diagrams of battery cells, support structures, and associated electronic elements, according to various aspects as described herein.

FIGS. 2A-2B illustrate exemplary diagrams of a battery box (enclosure), and the relative positions of elements therein, according to various aspects described herein.

FIG. 3A-3E illustrate exemplary diagrams of a vehicle, the placement of the battery box (enclosure) and the relative positions of the elements therein, according to various aspects as described herein.

FIG. 4 illustrates an exemplary computing environment, device(s), and system(s), according to various aspects as described herein.

FIG. 5 illustrates an exemplary diagram of battery cells, support structures, and associated electronic elements, according to various aspects as described herein.

FIG. 6 illustrates an exemplary diagram of a battery cell mount, according to various aspects as described herein.

FIG. 7 illustrates an exemplary diagram of battery cells, support structures, and associated electronic elements, according to various aspects as described herein.

FIG. 8 illustrates an exemplary diagram of a battery cell, according to various aspects as described herein.

FIGS. 9-10 illustrate exemplary diagrams of bus bars, according to various aspects as described herein.

FIG. 11 illustrates an exemplary diagram of a battery box (enclosure), and the relative positions of elements therein, according to various aspects described herein.

FIG. 12 illustrates an exemplary diagram of an air channel enclosure, according to various aspects described herein.

FIG. 13 illustrates an exemplary diagram of air channels with respect to battery assemblies, according to various aspects described herein.

FIG. 14 illustrates an exemplary diagram of a linear ball bearing and rail connections, according to various aspects described herein.

EXHIBIT A illustrates an exemplary exhibit of a separated battery drawing and information related thereto and an exemplary datasheet for an exemplary thermal-electrical device, according to various aspects described herein.

### DETAILED DESCRIPTION

In the following description of the various embodiments, reference is made to the accompanying drawings, which form a part hereof, and in which is shown by way of illustration various embodiments in which features may be practiced. It is to be understood that other embodiments may be utilized, and structural and functional modifications may be made.

Aspects of the present invention contemplate a battery enclosure, alternately, a battery box, of a generally rectangular shape and sized to fit the vehicle in which the battery box is installed. The battery box referenced herein may alternately be considered or call a battery drawer without departing from the scope of the present invention. In some embodiments, the battery box is constructed of steel; in other embodiments, the battery box is constructed of appropriate metal or composite material. Aspects of the present invention contemplate a plurality of side rails, each rail positioned on a side of the battery box to enable a slidable battery box which may be quickly accessed for installation purposes, maintenance purposes, etc.

An exemplary battery box may additionally incorporate or utilize one or more panels or lids to the battery box to, among other things, provide physical protection to the batteries contained therein. Furthermore, the panels or lids may additionally provide thermal regulation features, e.g., vents or the lack thereof, that enable or facilitate environmental control in, around, or near the batteries contained therein.

As illustrated in the figures, an exemplary battery box may additionally house or enclose one or more battery cells positioned in a line, wherein each line of batteries may be matched with an appropriate air channel to facilitate the removal of heat from in, around, or near the batteries. In some embodiments, an exemplary air channel may be made of steel, metal, composite, or other appropriate material. In an exemplary embodiment, an air channel is perforated with holes, e.g., 4 mm holes, to allow or otherwise permit heated air from the batteries to enter the channel and then be removed from the channel, whether by passive means (conduction, air current due to thermodynamic processes, etc.) or active means (one or more fans position in, on, or near the air channel). These perforations may vary in size and placement without departing from the scope of the present invention. While the drawings may show a single row/line of batteries, it should be understood that an exemplary battery box may include a plurality of battery rows/lines without departing from the scope of the invention.

In an exemplary embodiment, the top of the channel may be sloped upward at an appropriate angle, e.g., two (2) degrees, as measured from a far end of the box positioned at a front end of the vehicle towards a near end of the box positioned at the rear end of the vehicle, as illustrated in the figures. Generally speaking, this physical arrangement allows heated air to escape, leave, or otherwise exit the channel even if an active cooling element (e.g., fan) fails, as the heated air rises and allows the inclined plane of the top of the channel. In some embodiments, one or more electronic elements, such as but not limited to, a microcontroller/microprocessor, one or more temperature-sensing elements, etc., may be utilized to monitor or control operation of one or more elements on the present invention to determine, among other things, a battery failure of one of the batteries in the battery box. Such a battery failure may indicate a unique code or location information, in which to aid servicing of the affected battery. Such information may be communicated to the driver or appropriate user, so that the person may access the battery box and perform necessary maintenance tasks to return the battery to operation or replace the battery as appropriate, thereby returning the vehicle to operational status. Furthermore, in the event of a catastrophic fire of the battery pack(s), the battery box may be quickly accessed, opened, and/or removed from the vehicle without tools, due to the design of the present invention. As such, while a fire would likely consume the batteries and/or the battery box, with the box hanging off the back of the vehicle or removed from the vehicle, the vehicle, cargo, and/or passengers should be able to escape relatively unharmed by the fire. As a result, this design advantageously facilitates ease of maintenance, safety, and lower cost of production.

According to aspect of the present invention, the batteries may be constructed of one or more lithium cells, such as but not limited to, 90 “32700” type LiFe04 cells. In an exemplary embodiment, these cells are at least 3.2 volts at 6 ah each; however, other appropriate voltages and amperages may be utilized without departing from the scope of the present invention. In the exemplary embodiment, they are wired in parallel with each other, using conductive strips or bus bars, e.g., copper, arranged in a grid pattern. In this embodiment, a similar configuration is utilized for both the positive and negative sides of the battery. Generally speaking, this grid patterns provides additional security and rigidity to the design.

According to aspects of the present invention, one or more batteries may be surrounded on one or more sides by one or more rows of Peltier junction (“p-junction”) elements. In an embodiment, the junction elements are unpowered. When positioned in this manner, the heat coming from the batteries create or otherwise enable a temperature differential across one or more of the p-junctions. Based on the physical characteristics of the p-junction, the temperature differentials cause a voltage between the terminals of the p-junctions—this voltage, in turn, powers one or more active cooling elements attached to the grid, e.g., fans, which move or otherwise circulate the heated air into the one or more air channels via the perforated wall(s) of the channels. As the heat around the batteries increases, so does the voltage created by the p-junctions, which in turns causes the fan(s) to operate faster. As the heat decreases, the voltage decreases accordingly, causing the fan(s) to operate slower. More detailed exemplary embodiments of the cell arrangements, fan arrangement and placement, etc. are described below. Due to this inventive arrangement and usage of elements, aspects of the present invention provide a stable self-regulating system for managing or otherwise controlling the temperature of the batteries and the environment in, around, or near the batteries, without the need for any complex control hardware or software that may introduce additional points of failure. The present invention therefore avoids these unnecessary complexities.

According to aspects of the present invention, while the battery box is generally rectangular in shape, the dimensions of the box are determined by the make and model of vehicle into which it will be installed, e.g., make/model-dependent X and Y coordinated measurements. The “Z” dimension is an appropriate measurement to accommodate the batteries standing on end as well as the one or more sloped air channels positioned within the box. Exemplary illustrations of these dimensions are shown throughout the figures. In other words, the inventive aspects of the present invention do not necessarily depend on the precise dimensions of the structure, as should be apparent from above. Additionally, the slide rails indicated above may by affixed, attached, or otherwise positioned on the exterior of the battery box to enable the slidable features noted above. In some embodiments, attachment may be accomplished with mechanical fasteners attached to the vehicle. Furthermore, the panels/lids indicated above are generally positioned on the top of the battery box to enable easy access to the interior of the box and the batteries positioned therein. In some embodiments, the top of the box is divided into equal sections with corresponding panels/lids that can each be opened independently of the others; in other embodiments, the top of the box may be unequally divided or covered by a single panel/lid. The figures illustrate one or more lids/panels opened at various angles, removed, or closed. One or more channel fans, positioned at the end of each channel, may be powered via the vehicle's electrical system, the grid described above, or some combination thereof. Generally speaking, the fans should not tap into or otherwise utilize a traction battery for power. One or more exemplary fans are illustrated throughout the figures.

In an exemplary embodiment, battery cells of 3.2 volts operating at 6 Ah generate 19.2 Wh each. Accordingly, when arranged in a configuration of 9×10 cells in parallel, the configuration would ideally yield a voltage of 3.2V @ 540 Ah, for 1,728 Wh. As noted above, exemplary wiring may utilize copper bus bars running the length and width of the cells on both the positive and negative poles of the cells. According to aspects of the present invention, the bus bars and any exposed battery-cell fasteners may be covered with a non-conductive adhesive or appropriate covering after assembly, but generally prior to fan installation.

According to aspects of the present invention, the battery cell fans may be installed or otherwise arranged on perpendicular planes to the battery cells, e.g., a matrix of fans. In some embodiments, CPU fans are utilized—however, any appropriate fans may be utilized without departing from the scope of the invention. For the purposes of further description, the top of the battery array is considered the side furthest from the side with no p-junctions, i.e., the bottom. In other words, one or more p-junctions are positioned “surrounding” the battery unit on three sides—the top, left, and right. The fan(s) at the top of the battery array are anticipated to need the greatest voltage (e.g., to operate faster to remove heat), and are therefore powered by the p-junctions at the top of the battery array. It is also within the scope of the present invention to utilize the one or more of the elements herein to provide heat during periods of cold temperatures.

While particular electrical or computerized elements may be described above, one of skill in the pertinent arts understands that other elements may be utilized to achieve the same or similar means, methods, or results without departing from the scope of the present invention.

As noted above, and according to aspects of the present invention, one or more computing devices, microcontrollers, or microprocessors, or some combination thereof, may be utilized for a battery management system (BMS), where the BMS operates to identify a “battery health”, e.g., battery failure. In some embodiments, each battery has a microcontroller board is operatively connected to the battery, for communication with the BMS. One or more electrical elements may be made between each board and its corresponding battery, enabling the BMS to, among other things, turn charging on or off dynamically based on overall battery health, and the rate, charge level, and state of charge (“SOC”) of each battery connected thereto. Additionally, while not illustrated in the figures, one or more panels/lids may have one or more electrical elements for determining an “open/closed” status of the corresponding panel/lid, which may be additionally monitored or reported by the BMS.

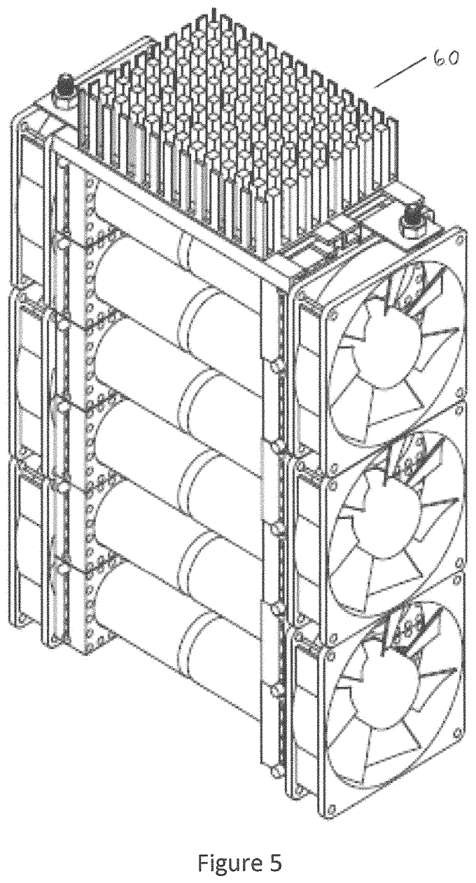

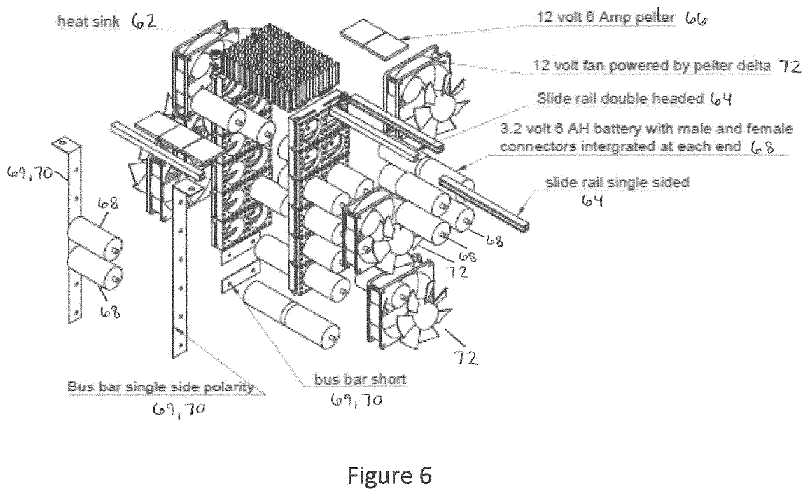

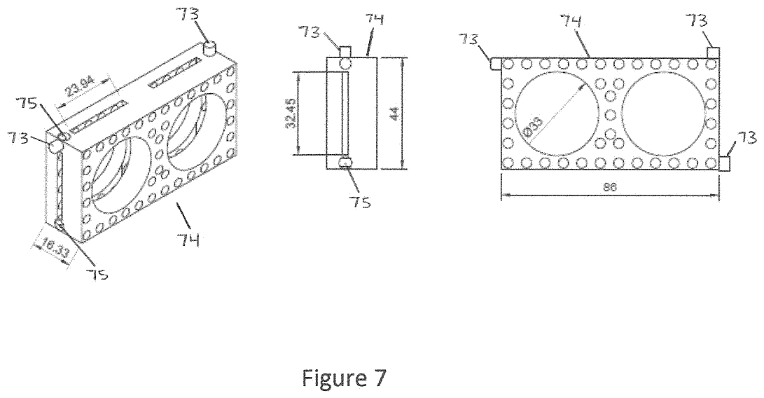

In other exemplary embodiments, such as those described or included below, other configuration of elements may be utilized, without departing from the scope of the present invention. By way of demonstration and not limitation, the following comprises, among other things, a brief description of designs of exemplary components of this system—another battery configuration and a box that the battery configuration may be housed in. In the following description, these exemplary components are designed to work together as a “matched set”. For example, a battery itself may be composed of eight types of components, such as those demonstrated in FIG. 5 (an “assembled” view”) and FIG. 6 (a “detailed” view). As illustrated in FIG. 6, a heat sink 62, which is shown in this view as approximately the size of the “footprint” of the overall unit 60. One or more steel strip or slide rails 64 may act as support structures and temperature conductors between the heat sink 62 and the next component, thermoelectric Peltier elements 66 (or other electric components that exhibit similar thermoelectric characteristics), the battery cells 68 themselves. In one example, one or more of the batteries are 3.2 volts at 6 Amp Hours (Ah), which provides 19.2 Watt-hours (Wh) of power. As should be apparent, batteries of other voltages and amperages may be utilized without departing from the scope of the present invention. As shown in FIG. 6, the unit 60 may additionally include one or more bus bar of varying lengths, e.g., elements 69 and 70. As illustrated, stackable battery mounts 74 (described below and illustrated in FIG. 7, which hold 2 batteries), rails 64 to hold the Peltier elements 66 in place, with cooling fans 72 positioned throughout. For example, one or more 12-volt equipment cooling fans may be utilized. With respect to the Peltier elements, in some embodiments, these elements 66 comprise one or more 40×40×4 mm thermal-electrical devices that are placed in two rows of 3, being held in place by the rails 64 listed above. An additional steel strip may be placed on top of the Peltier elements 66 to act as a thermal conduit to transfer temperature from the steel to the heat sink. Their thermal-electric properties can be found in Appendix A of this document. For example, model number TEC1-12706 from TE Technology Inc. may be utilized.

Turning now to FIG. 7, the primary structure of the battery configuration is provided by the battery mounts 74. By way of demonstration and not limitations, one or more battery mounts may be configured using the measurements illustrated (for example, in FIG. 7, measurement units are in millimeters). In this example, the mounts 74 have 4 mm pegs 73 on one side and corresponding 4 mm holes 75 on the side opposite the pegs 73, such that the units can be assembled and stacked as required. In other embodiments, one side of a mount 74 may have some configuration of pegs 73 and holes 75 that have corresponding holes 75 and pegs 73, respectively, on the side opposite to allow for stacking of mounts. In some embodiments, the mounts may also feature many 4 mm holes that transcend the width of the mounts for air flow to cool the batteries. The mounts additionally include one or more slots, e.g., six slots, to insert the bus bars that will electrically link the batteries. In some embodiments, the mounts 74 are constructed of a non-conductive material such as plastic, ceramic, or other non-conductive material, and the battery cells 68 are installed in the 33 mm holes inserted on the side with the larger edge to provide better stability.

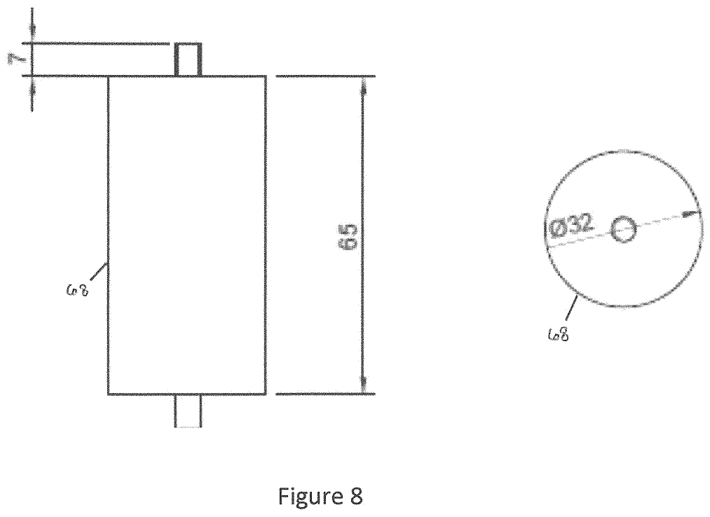

FIG. 8 demonstrates an exemplary battery cell 68. In some embodiments, one or more of the batteries may be a 3.2 volt 6 Amp Hour (Ah) cell, as noted above. As is generally known, each end of the cell 68 corresponds to the positive and negative “sides” of the cell. Each cell 68 is integrated with fastener connections—male connector for the negative side and female for the positive side. These fasteners are integrated by the manufacturer. In this example shown in FIG. 8, the body of a cell 68 may measure 65 mm and each fastener is 7 mm, for a total length of 72 mm, and the body measures 32 mm in diameter.

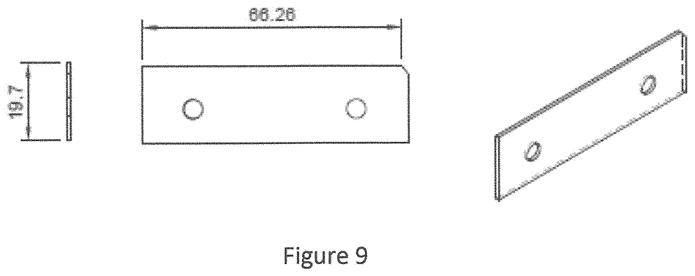

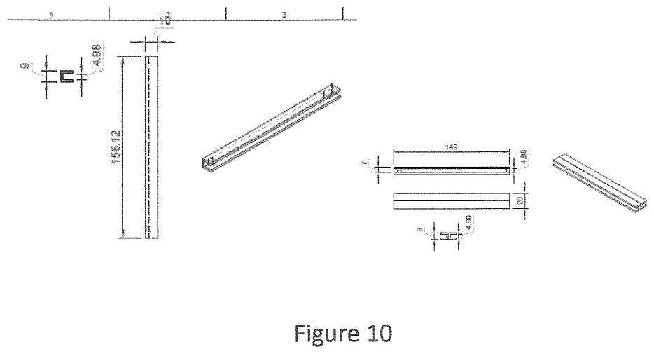

FIGS. 15 and 16 illustrate exemplary embodiments of bus bars, as introduced above. In these exemplary embodiments, the bus bars are generally two different sizes, hereinafter referred to as “short” (FIG. 9) and “long” (FIG. 10). In some embodiments, the bars are 1 mm thick. However, the bars may be of an appropriate thickness as needed to configure the elements as described throughout. As shown in the FIGS, one long bar may be attached to one polarity side of the battery, where the long bar has a 90-degree turn at the top with a hole to install a nut and bolt (or other appropriate fastener) to serve as the polarity terminal. The short bars may then connect each of the batteries horizontally on each side's polarity. Advantageously, this arrangement allows the battery cells to be connected in parallel. In FIG. 10, “long” rails may be installed on top of the upper most battery mounts; they also come in two different configurations (single and dual). The primary purpose of these rails is to support Peltier elements in place.

Now that various exemplary elements are described and returning to FIG. 5, the example of FIG. 5 illustrates a battery configuration with twenty-four (24) battery cells in this configuration. This exemplary configuration has 12 rows each with 2 cells in series and the series rows connected in parallel, giving an electrical output of 6.4 volts at 72 Ah, or 460 Wh. (Batteries with different voltages and amperages determine the electrical output of the configuration). The cells 68 are held in place by the battery mounts 74. There is one mount 74 on each side of the assembly. Typically, these mounts 74 are made of plastic or other non-conductive material, as noted above. Additionally, a mount may be colored red for the positive side and black for the negative side of the battery cells 68. These mounts 74 may have slots integrated into their design to allow in installation of bus bars in both a horizontal and vertical configuration. Additionally, the design of the mounts 74 may incorporate multiple holes to allow air passage to cool the batteries when excessive heating occurs (e.g. FIG. 7). Air may be forced through these holes by one or more fans 72 attached on the outside of the assembly 60. Stated another way, the assembly 60 is six battery mounts 74 high, allowing the total of 24 cells. At the top of the assembly 60 is a rail system facing inwards on the two outer edges and with a center unit (rail) facing to both directions. These rails hold the Peltier elements 66 in place. These Peltier elements 66 are installed in two rows of three units each and wired in series, enabling these elements 66 to “harvest” the waste heat generated by the batteries during normal usage. This waste heat is transformed into electrical energy by the Peltier elements 66 and used to power the fans previously mentioned, thereby powering this venting system that inputs air flow from the vehicle's HVAC system, and is detailed in the box section above and below. By inputting or injecting the A/C air into the battery assembly, which serves to increase the delta T—an increasing delta of temperature (ΔT°) on each side of the Peltier elements 66—and increase the voltage generated by the elements 66, causing the fans to spin faster, thereby cooling the batteries proportionately. Generally speaking, one side of the fans input cooler air from the box's air channels (explained elsewhere with respect to the box), while the other side draws air out of the battery assembly and into an output air channel of the box. Next, there are two steel strips on top of the Peltier rows that extend above the plane of the rail system to serve as a thermal conduit to the heat sink 62 that sits on top of the assembly. This heat sink 62 serves to insure a more efficient thermal transfer of waste heat and or HVAC input air.

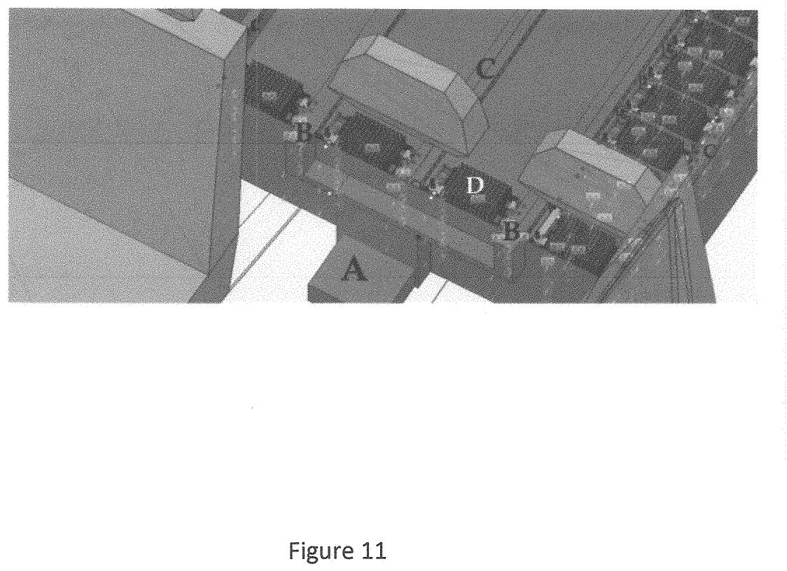

While one particular box configuration is discussed above, other embodiments exist that incorporate aspects of the present invention. For example, FIG. 11 demonstrates the internal structure and arrangement of elements in another exemplary embodiment. The box itself is of a steel (or other appropriate material(s)) construction with dimensions appropriate to fit between the wheel wells of the vehicle which it is installed into, with a length generally that of the vehicle's cargo area and a height lower than the wheel wells, e.g., 25 mm. This can vary, however, depending on make and model of vehicle, without departing from the scope of the present invention. Like the box above, this exemplary embodiment of a box may be equipped with several components, e.g., two types of air channels for cooling (providing delta T's to Peltier elements), a mechanical interface to the vehicle's HVAC system, air channel cooling fans, linear ball bearing system, a locking mechanism, plug interfaces for the traction battery, and lids that also serve as a bases for the false floor. The following is a description and illustrations of each of these components.

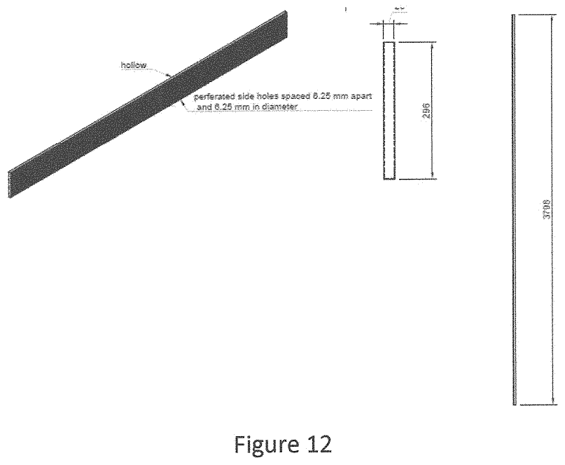

With respect to the air channels noted above, there may be one or more interfaces between the vehicle HVAC and the box, as illustrated in FIG. 11 at position A. In this example, position A attaches mechanically to the passenger side vents inside the cab of the vehicle to provide climate control air to the input vents, which are seen at position B. Position C shows one or more vents for expelling the air flow outside the box—the size, material, and specific location on the outside of the box is a variable depending on the make and model of vehicle it is installed into. Air channels shown at “B” and “C” have holes drilled in them at 90° relative to each other. Specifically, holes facing down to allow the HVAC air to enter the perforated air channel to be feed into the battery assemblies via the fans. At 90° there are holes to allow the HVAC air to transit across the heat sink. As seen in FIG. 7 at point “B” are next to each other and are the inputs, this eliminates any need for insulation between the two channels as they are the same temperature, the same conditions also apply at point “C”, which is the output. In some embodiments, there may be one or more perforated hollow air channels that run the length and depth of the box (see FIG. 12). These are located below the “B” and “C” channels, but are not expressly shown in FIG. 11. The perforated edges face the fans on the battery assemblies. Note that the length of this air channel like the box itself is variable depending on the length of the vehicles' cargo area.

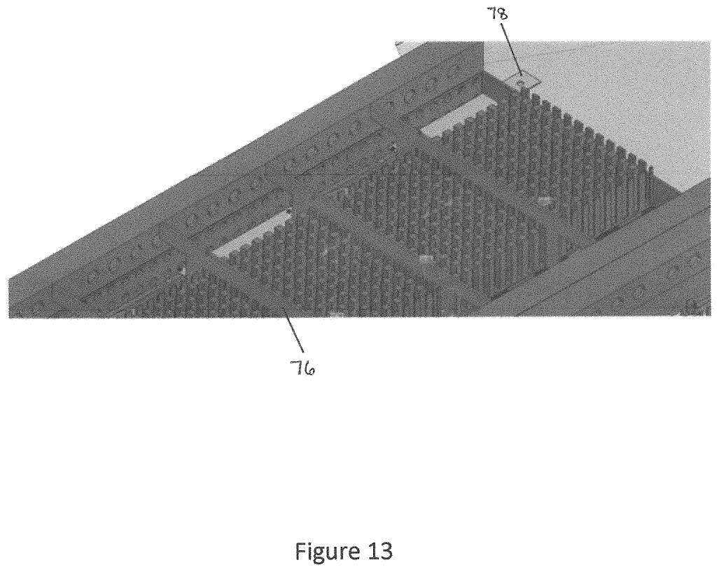

In FIG. 13, an exemplary embodiment demonstrates one or more air channels in relation to exemplary battery assemblies, e.g., the spaces in and around the assemblies. In addition, there are non-conductive barriers, e.g., elements 76 and 78, between the battery assemblies that serve two primary purposes. First, elements 76 and 78 electrically isolate any stray connections that might cause a short circuit or other electrical/mechanical damage (such as foreign material, moisture, dirt, or other unforeseen contaminants). Second, elements 76 and 78 help keep air flow from the HVAC system at some concentration of pressure by not allowing the air to disperse across the entire battery line. Additionally, there may be one or more openings in these barriers 76 and 78 to allow bus bars to connect the batteries. In FIG. 19, elements 76 and 78 are shown in exaggerated portions for display purposes.

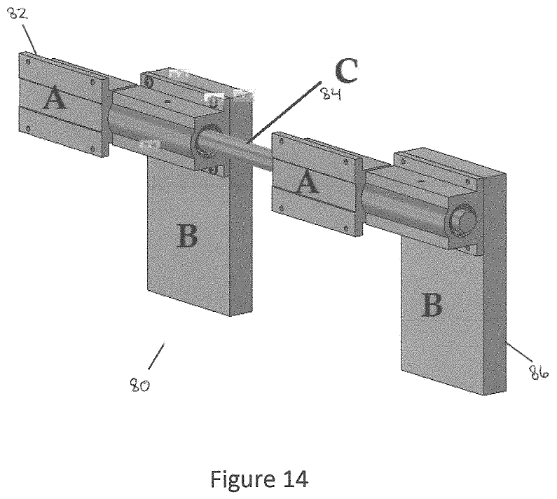

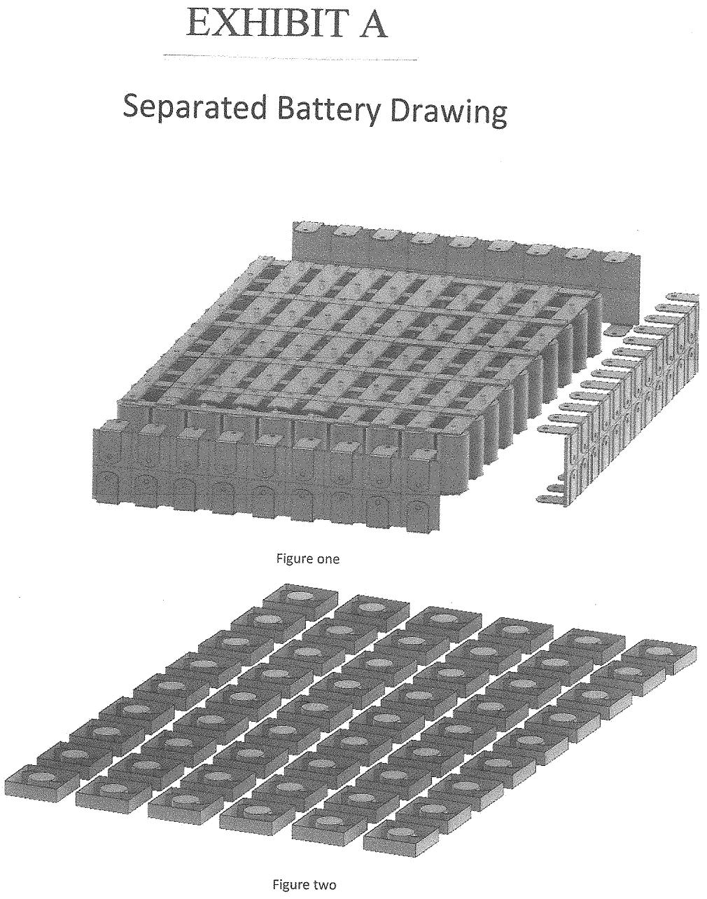

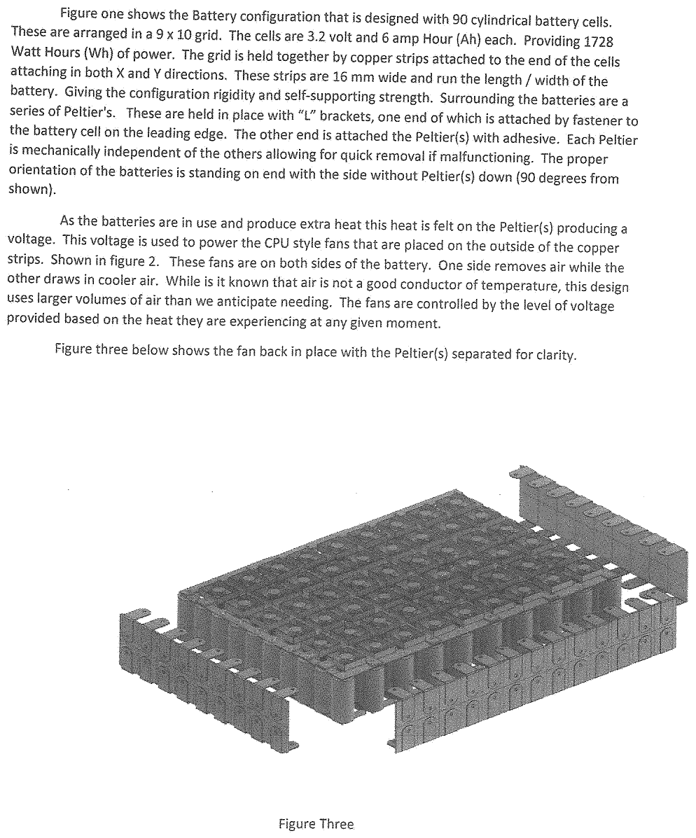

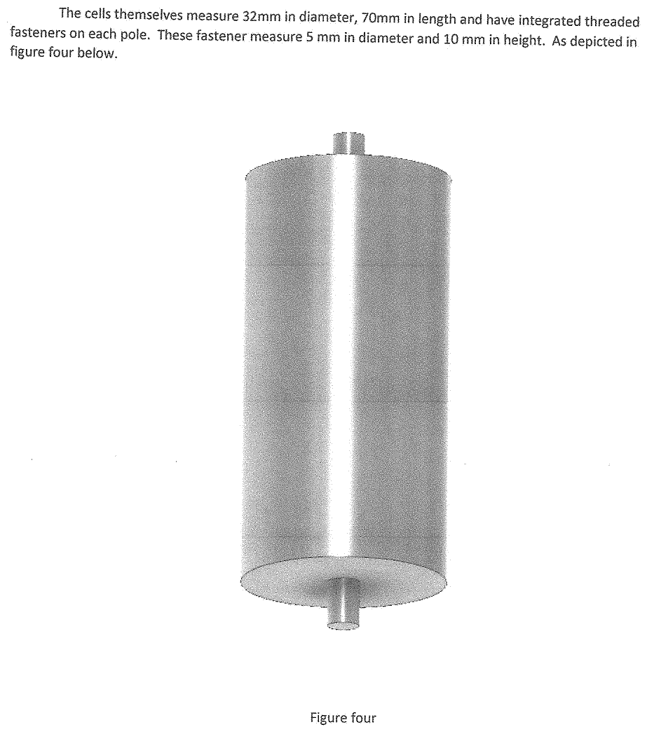

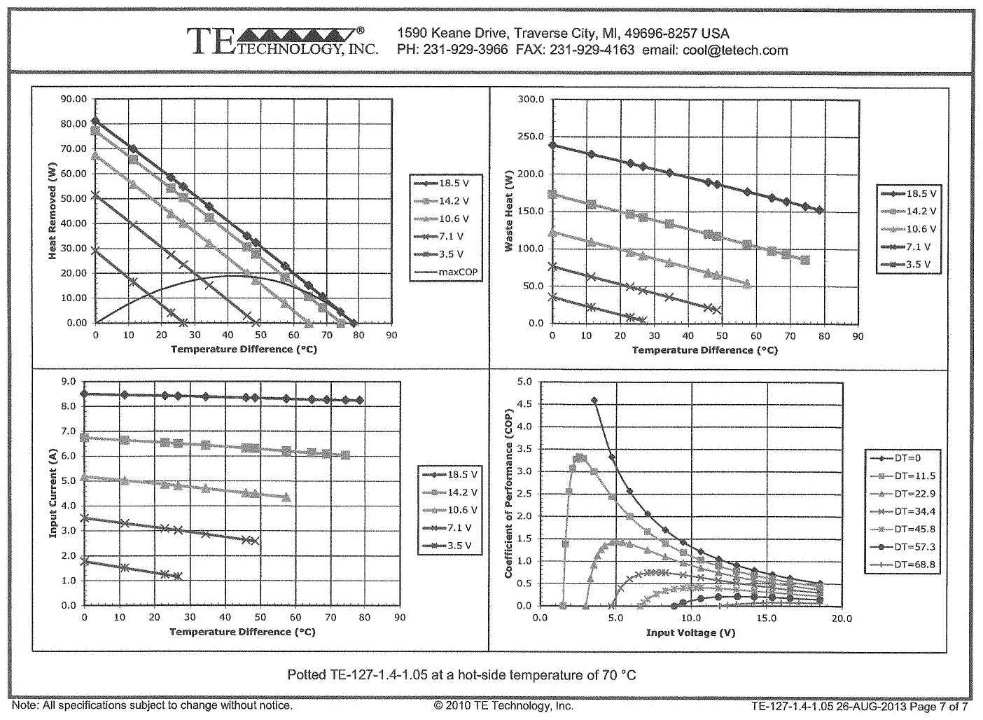

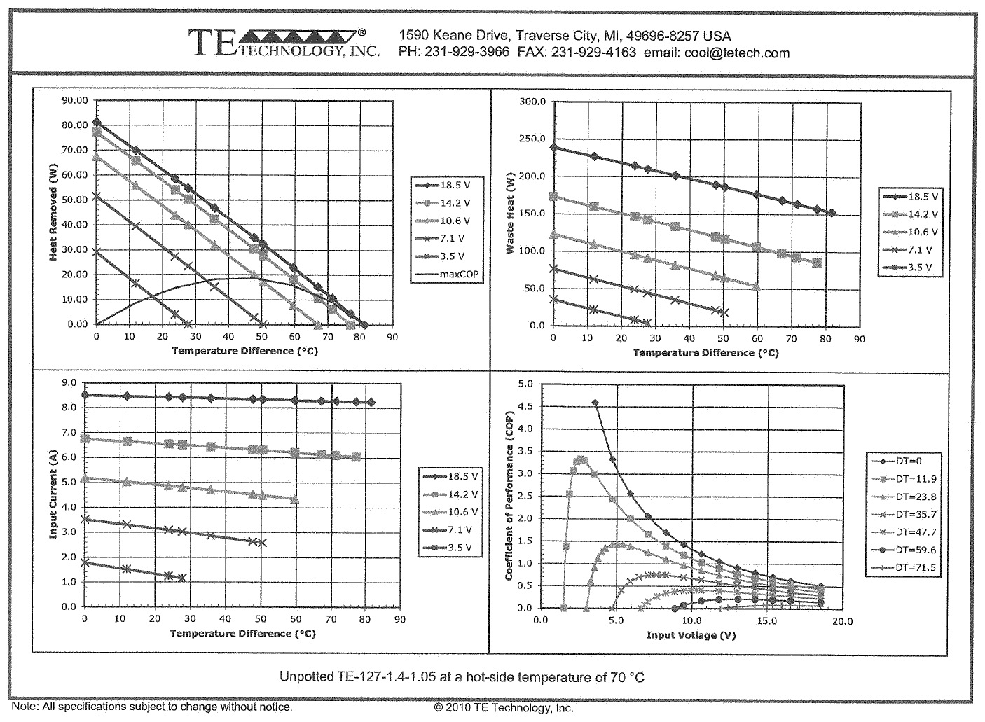

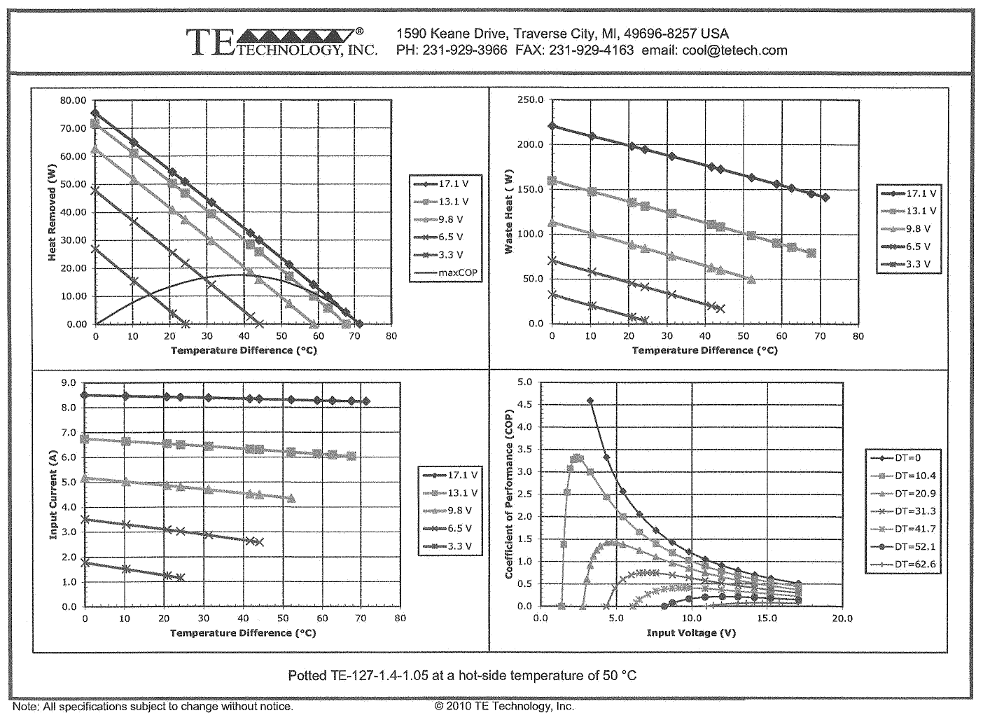

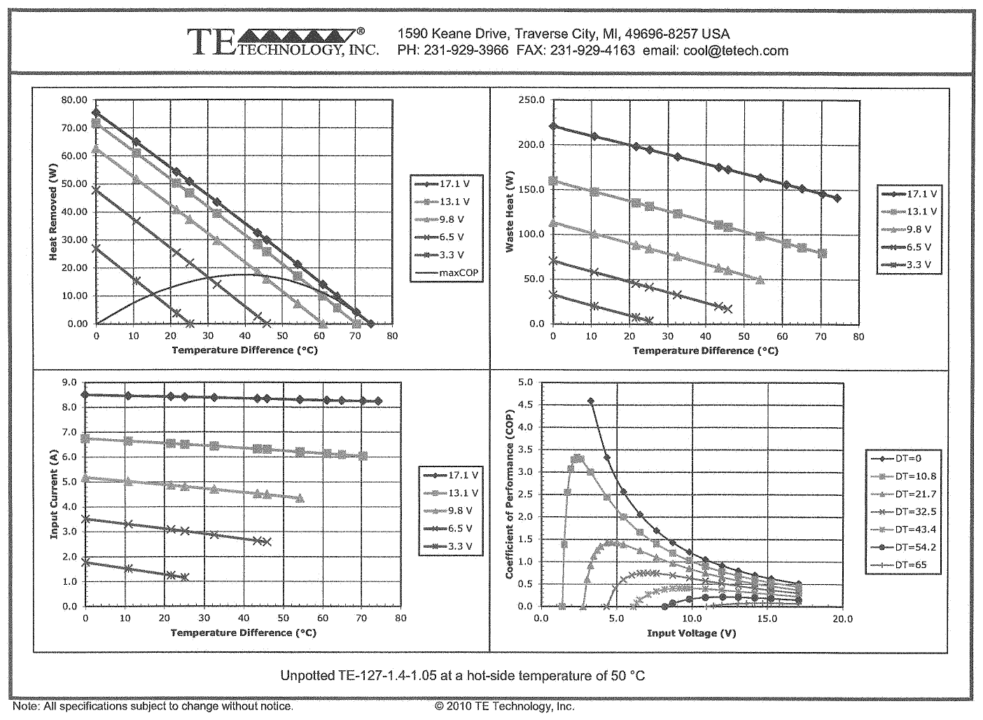

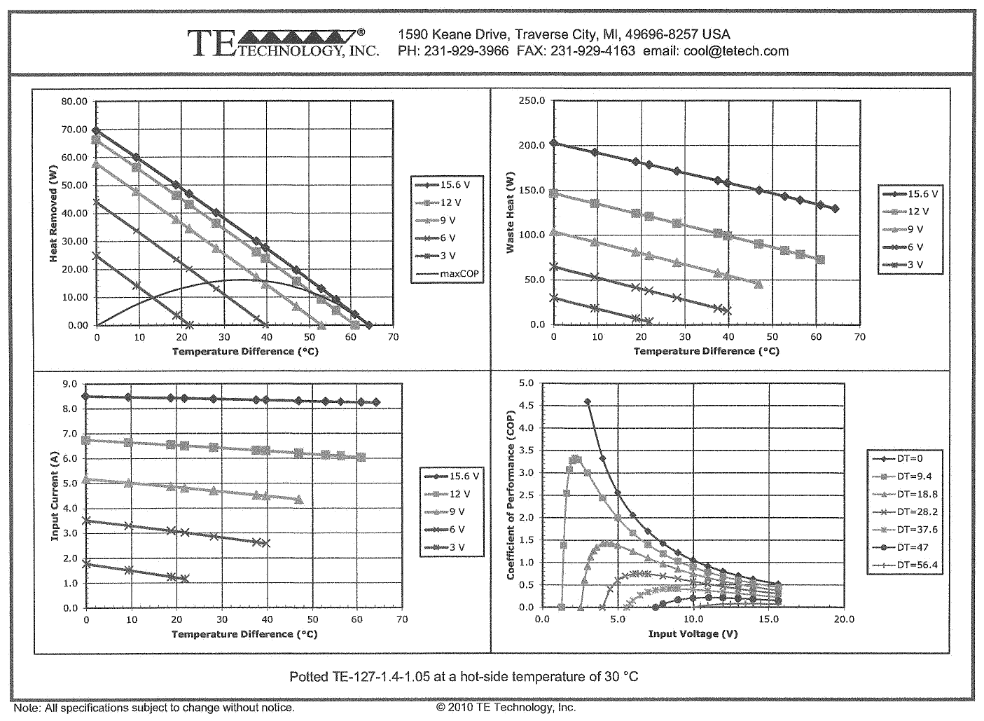

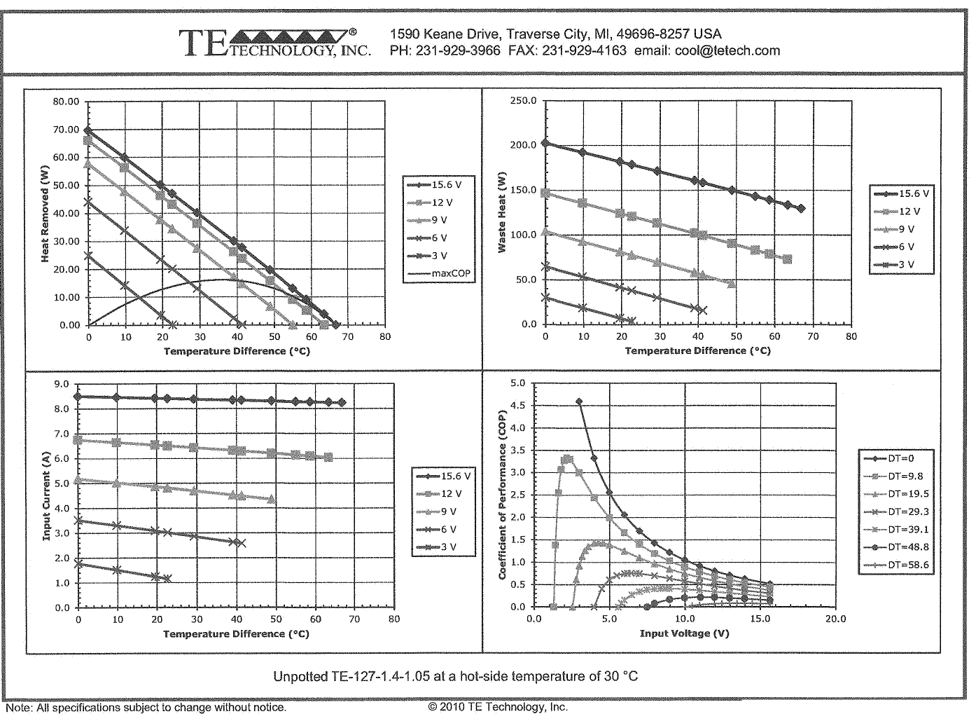

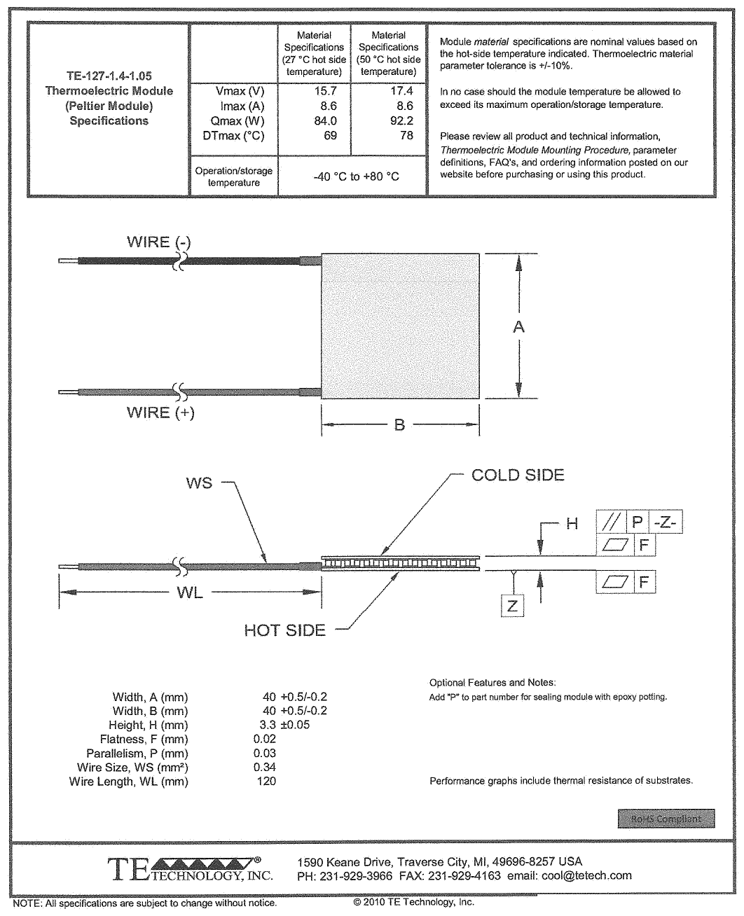

Finally, some embodiments of the present invention include a linear ball bearing and rail connections on the exterior sides of the box, allowing for quick removal of the box and its contents for maintenance and other access needs. An example of one or more of these connection units 80 are illustrated in FIG. 14, where at least one connection unit 80 is positioned and attached to the front of the box and at least one connection unit 80 is positioned and attached to the back of the box. In FIG. 14, elements 82 are linear ball bearing housings, which are those elements attached to the box, where bar 84 passes through the bearing housings 82 to prevent bar 84 from coming lose during normal operation. As illustrated, bar 84 passes through retaining structures of element 86, such that the ball bearings 82 have a point of reference for movement.

Advantageously, this combination of elements allows for several key benefits. First, the battery assemblies allow for self-regulation of temperatures without the need for complex and expensive liquid and/or microprocessor-controlled cooling systems. This self-regulation of temperature control allows for optimum battery performance regardless of the local weather. Second, the battery box is located inside the vehicle protecting it from the worst environmental hazards, such as road hazards, direct contact with water, and direct contact with humans for safety, theft and vandalism protections. Next, the box acts similar to a pull-out drawer, allowing for ease of access to the batteries for maintenance, upgrades, and/or other immediate needs. Fourth, the box has several input and output air channels (as described earlier) that enhance the battery assemblies ability to regulate their temperature. In summary, aspects of the present invention advantageously allow a slidable battery box to house one or more battery cells, with one or more elements arranged to both passively and actively control the temperature in, around, or about the batteries within the battery box, wherein the heated air within the battery box is removed from the box via one or more air channels positioned within the battery box. When combined with a BMS like described above, the batteries may be selectively charged and monitored to ensure proper operation.

One of ordinary skill in the pertinent arts will recognize that, while various aspects of the present invention are illustrated in the FIGURES as separate elements, one or more of the elements may be combined, merged, omitted, or otherwise modified without departing from the scope of the present invention.

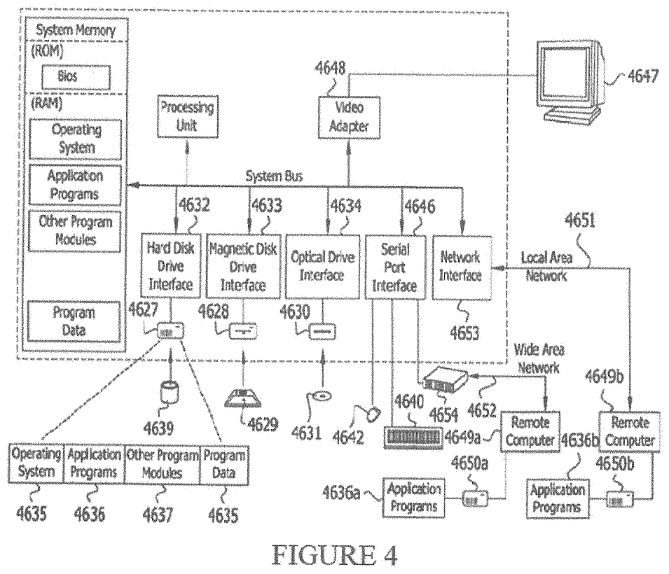

With reference to FIG. 4, an exemplary system for implementing aspects of the invention includes a general-purpose computing device in the form of a conventional computer 4320, including a processing unit 4321, a system memory 4322, and a system bus 4323 that couples various system components including the system memory 4322 to the processing unit 4321. The system bus 4323 may be any of several types of bus structures including a memory bus or memory controller, a peripheral bus, and a local bus using any of a variety of bus architectures. The system memory includes read only memory (ROM) 4324 and random access memory (RAM) 4325. A basic input/output system (BIOS) 4326, containing the basic routines that help transfer information between elements within the computer 20, such as during start-up, may be stored in ROM 4324.

The computer 4320 may also include a magnetic hard disk drive 4327 for reading from and writing to a magnetic hard disk 4339, a magnetic disk drive 4328 for reading from or writing to a removable magnetic disk 4329, and an optical disk drive 4330 for reading from or writing to removable optical disk 4331 such as a CD-ROM or other optical media. The magnetic hard disk drive 4327, magnetic disk drive 4328, and optical disk drive 30 are connected to the system bus 4323 by a hard disk drive interface 4332, a magnetic disk drive-interface 33, and an optical drive interface 4334, respectively. The drives and their associated computer-readable media provide nonvolatile storage of computer-executable instructions, data structures, program modules, and other data for the computer 4320. Although the exemplary environment described herein employs a magnetic hard disk 4339, a removable magnetic disk 4329, and a removable optical disk 4331, other types of computer readable media for storing data can be used, including magnetic cassettes, flash memory cards, digital video disks, Bernoulli cartridges, RAMs, ROMs, and the like.

Program code means comprising one or more program modules may be stored on the hard disk 4339, magnetic disk 4329, optical disk 4331, ROM 4324, and/or RAM 4325, including an operating system 4335, one or more application programs 4336, other program modules 4337, and program data 4338. A user may enter commands and information into the computer 4320 through keyboard 4340, pointing device 4342, or other input devices (not shown), such as a microphone, joy stick, game pad, satellite dish, scanner, or the like. These and other input devices are often connected to the processing unit 4321 through a serial port interface 4346 coupled to system bus 4323. Alternatively, the input devices may be connected by other interfaces, such as a parallel port, a game port, or a universal serial bus (USB). A monitor 4347 or another display device is also connected to system bus 4323 via an interface, such as video adapter 4348. In addition to the monitor, personal computers typically include other peripheral output devices (not shown), such as speakers and printers.

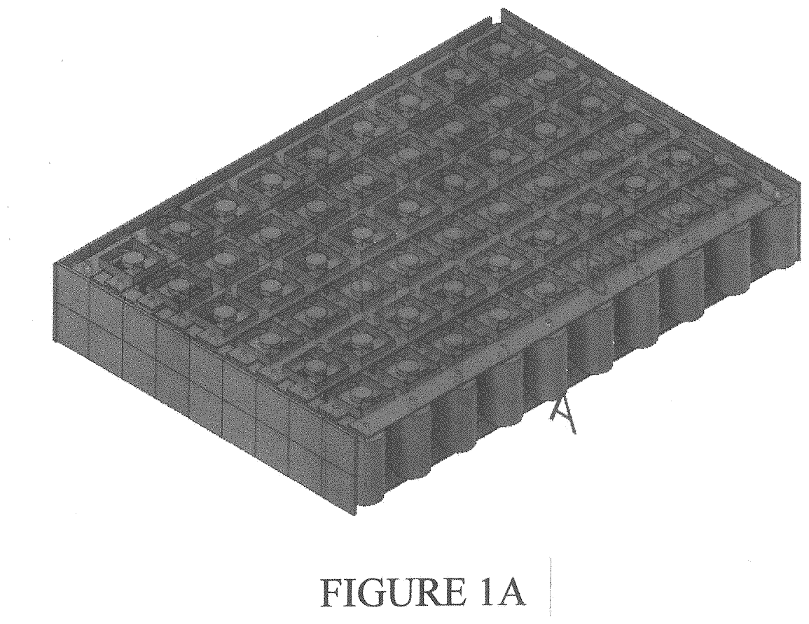

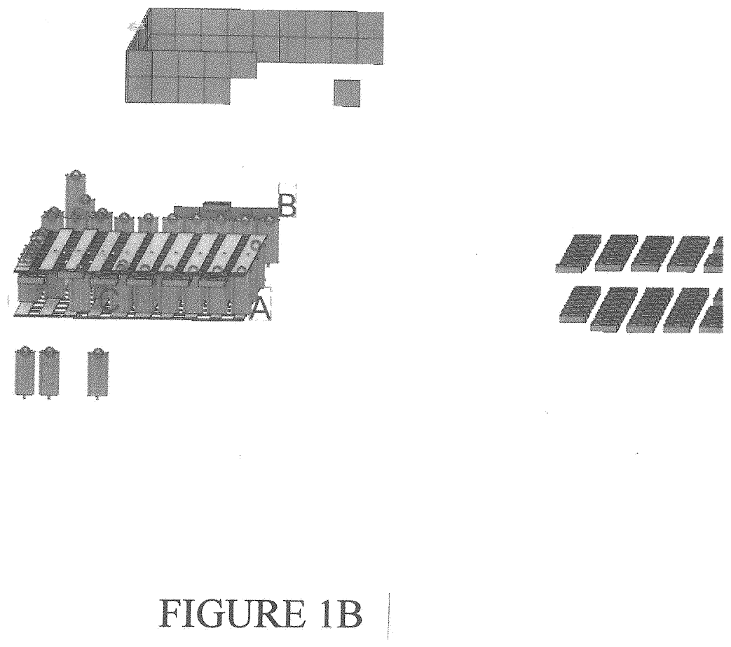

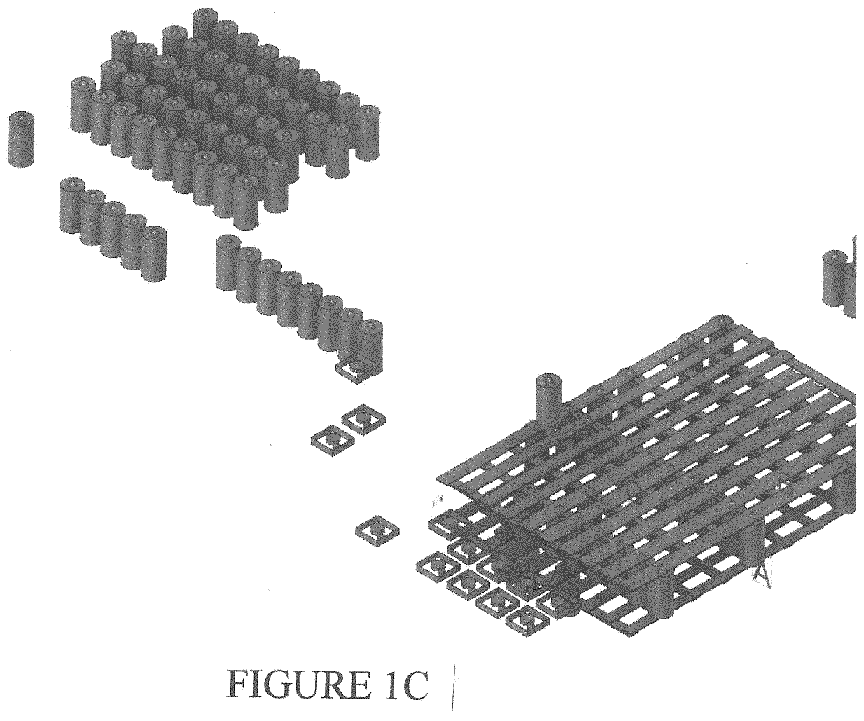

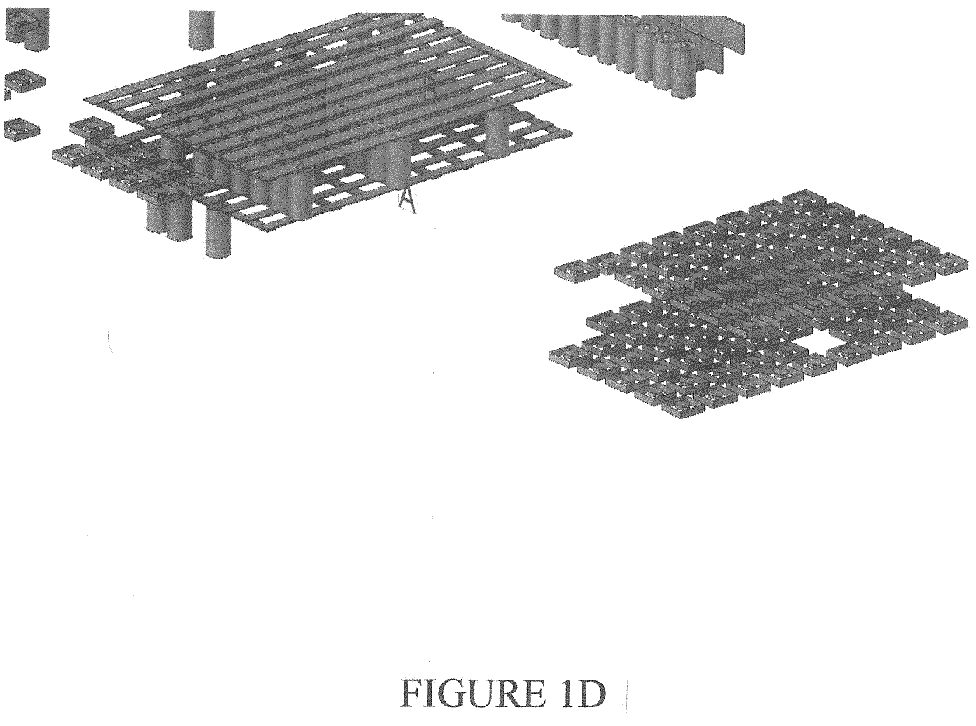

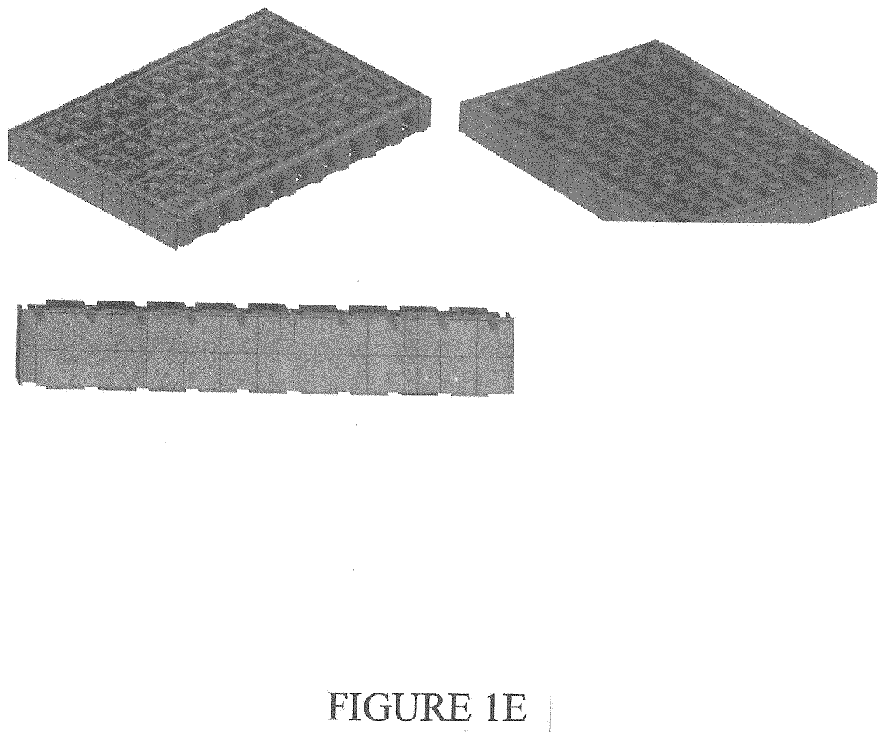

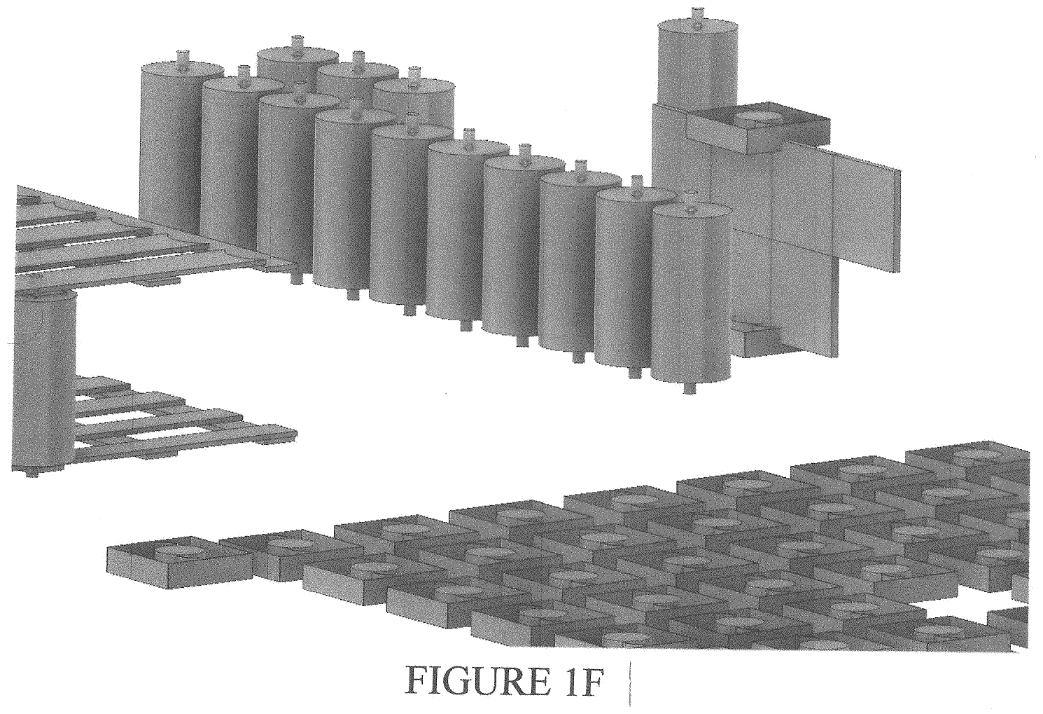

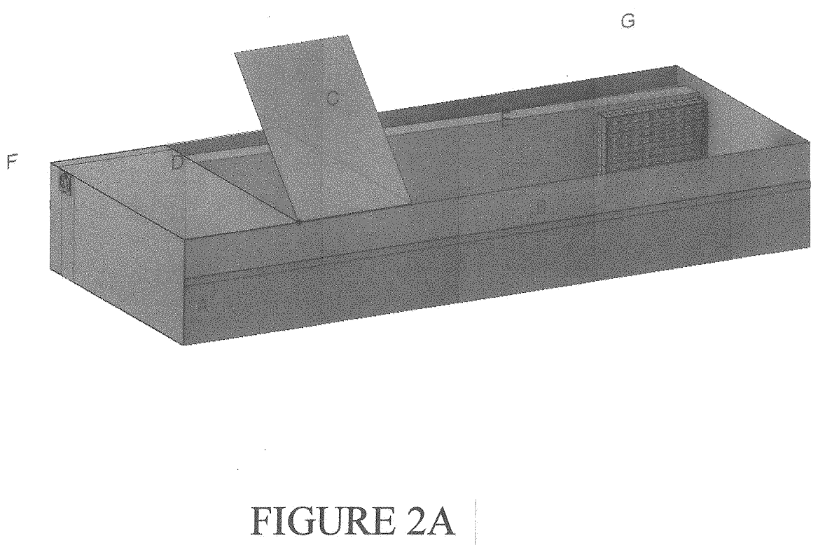

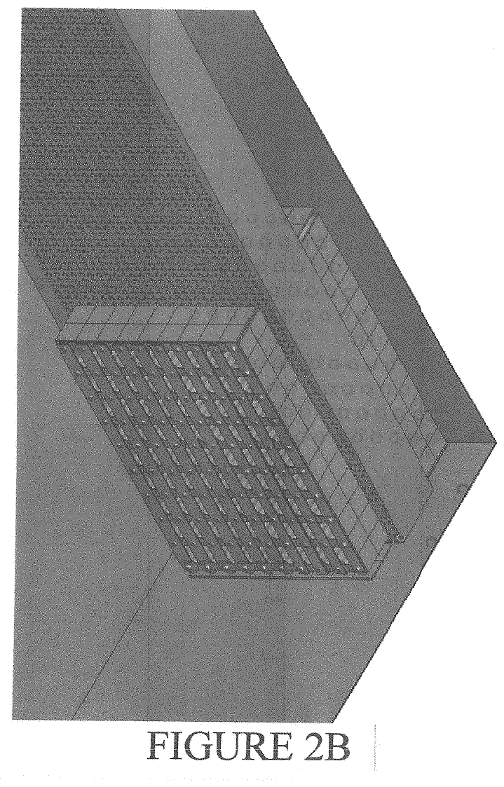

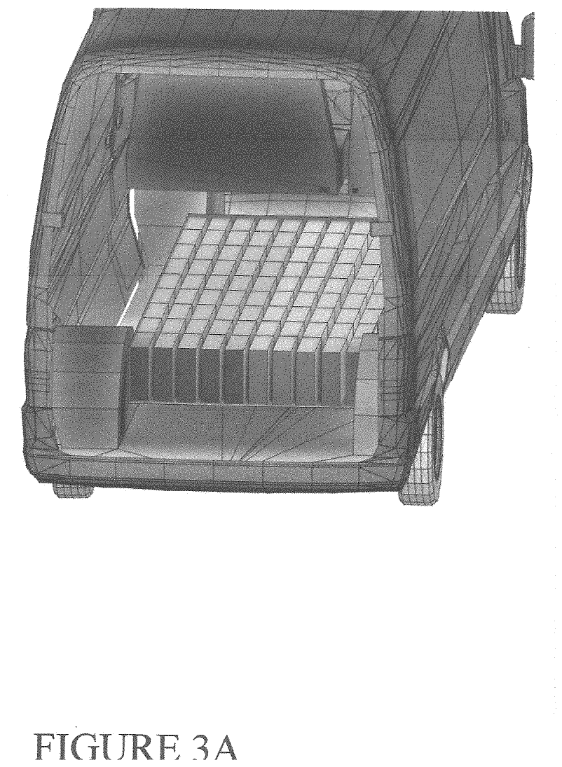

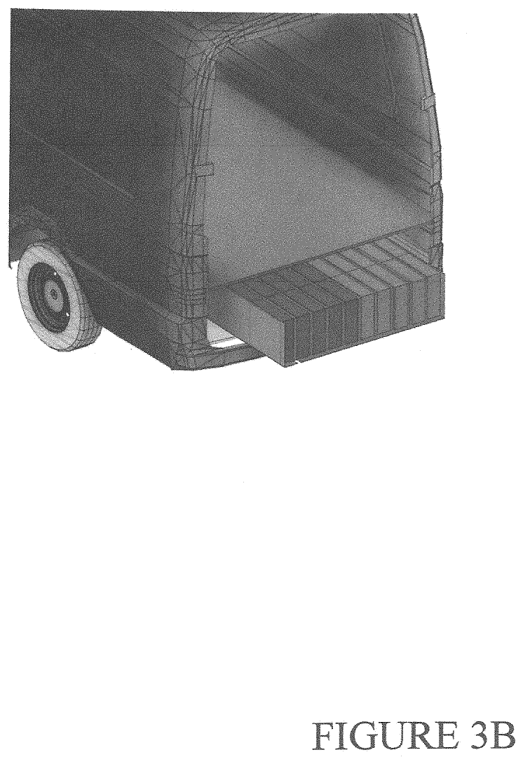

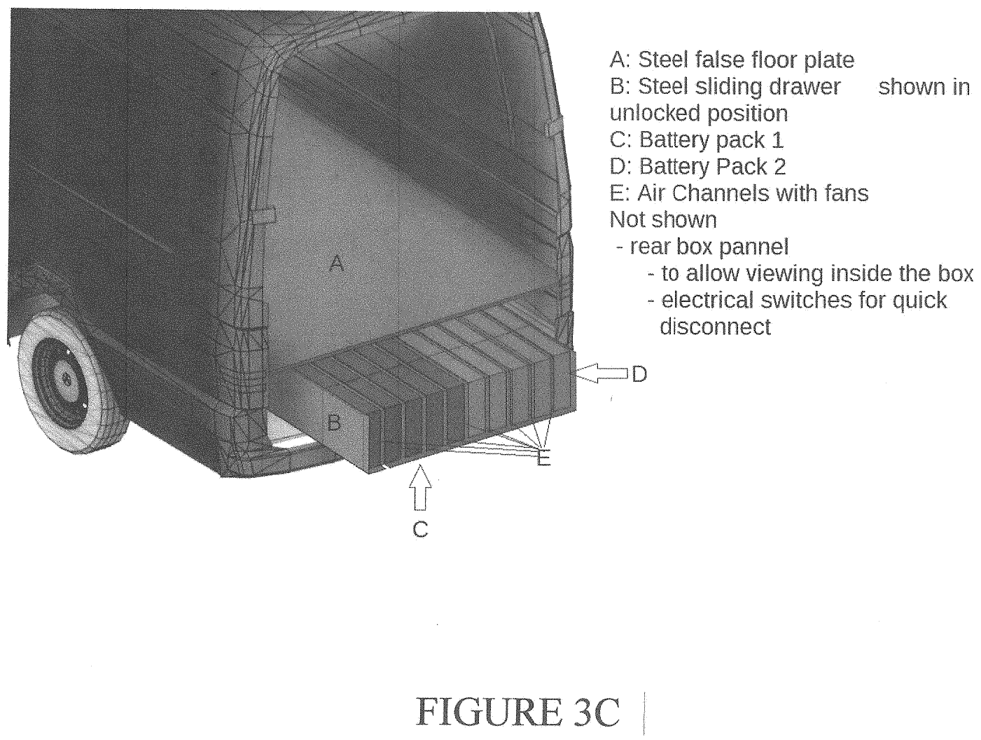

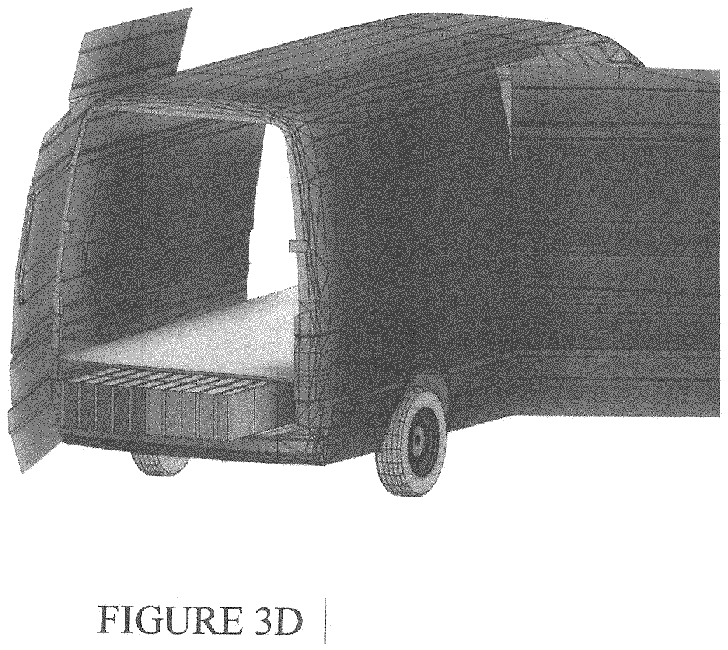

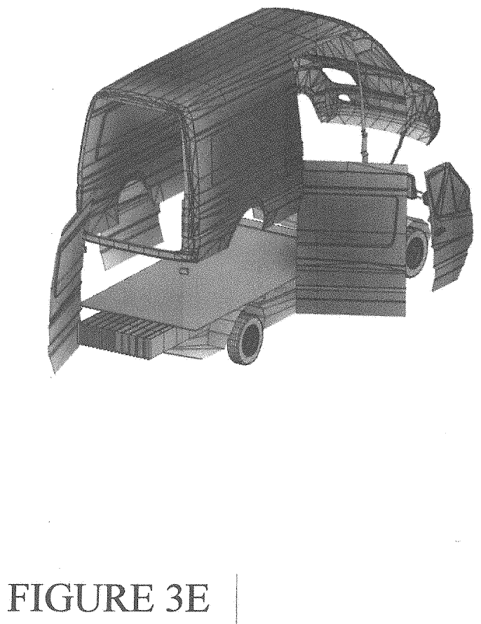

The computer 4320 may operate in a networked environment using logical connections to one or more remote computers, such as remote computers 4349a and 4349b. Remote computers 4349a and 4349b may each be another personal computer, a server, a router, a network PC, a peer device or other common network node, and typically include many or all of the elements described above relative to the computer 4320, although only memory storage devices 4350a and 4350b and their associated application programs 36 a and 36 b have been illustrated in FIG. 1. The logical connections depicted in FIG. 6 include a local area network (LAN) 4351 and a wide area network (WAN) 4352 that are presented here by way of example and not limitation. Such networking environments are commonplace in office-wide or enterprise-wide computer networks, intranets and the Internet.

When used in a LAN networking environment, the computer 4320 is connected to the local network 4351 through a network interface or adapter 4353. When used in a WAN networking environment, the computer 4320 may include a modem 4354, a wireless link, or other means for establishing communications over the wide area network 4352, such as the Internet. The modem 4354, which may be internal or external, is connected to the system bus 4323 via the serial port interface 4346. In a networked environment, program modules depicted relative to the computer 4320, or portions thereof, may be stored in the remote memory storage device. It will be appreciated that the network connections shown are exemplary and other means of establishing communications over wide area network 4352 may be used.

One or more aspects of the invention may be embodied in computer-executable instructions (i.e., software), such as a software object, routine or function (collectively referred to herein as a software) stored in system memory 4324 or non-volatile memory 4335 as application programs 4336, program modules 4337, and/or program data 4338. The software may alternatively be stored remotely, such as on remote computer 4349a and 4349b with remote application programs 4336b. Generally, program modules include routines, programs, objects, components, data structures, etc. that perform particular tasks or implement particular abstract data types when executed by a processor in a computer or other device. The computer executable instructions may be stored on a computer readable medium such as a hard disk 4327, optical disk 4330, solid state memory, RAM 4325, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

A programming interface (or more simply, interface) may be viewed as any mechanism, process, or protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software. By way of example, and not limitation, terms such as application programming interface (API), entry point, method, function, subroutine, remote procedure call, and component object model (COM) interface, are encompassed within the definition of programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g. information placed in a buffer, file, etc. separate from information flow between the code segments) or non-existent, as when one code segment simply accesses functionality performed by a second code segment. Any or all of these aspects may be important in a given situation, e.g., depending on whether the code segments are part of a system in a loosely coupled or tightly coupled configuration, and so this list should be considered illustrative and non-limiting.

This notion of a programming interface is known to those skilled in the art and is clear from the provided detailed description. Some illustrative implementations of a programming interface may also include factoring, redefinition, inline coding, divorce, rewriting, to name a few. There are, however, other ways to implement a programming interface, and, unless expressly excluded, these, too, are intended to be encompassed by the claims set forth at the end of this specification.

Embodiments within the scope of the present invention also include computer-readable media and computer-readable storage media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general-purpose computer, special purpose computer, or special purpose processing device to perform a certain function or group of functions

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1: A electric vehicle battery enclosure system, said system comprising:
One or more battery cells;
an enclosure having a generally rectangular shape, said one or more battery cells positioned therein, said one or more battery cells arranged in one or more lines, wherein one or more of each line of batteries has an air channel associated thereto, each air channel facilitating removal of heat from in, around, or near said batteries, each said air channel having a sloping upper surface and an opening to enable flowing of air within the channel; and
one or more passive electrical elements, said passive elements having at least a first side and a first terminal, and a second side and a second terminal, said first side being placed in thermal contact with said battery cells, wherein a temperature differential between said first side and said second side creates a voltage differential across the first and second terminals, said passive electrical elements being in electrical communication between one or more fans, whereby the heat generated by the battery cells enables the passive electrical elements to power said fans at a rate generally proportional to the generated heat.

2: The electric vehicle battery enclosure system of claim 1, said system further comprising one or more electronic control elements, said electronic elements being in electrical communication with one or more secondary electronic elements, said secondary electronic elements being associated with one or more of said battery cells, said secondary electronic elements selectively monitoring a status of the associated battery cells.
